(19) United States
(12) Patent Application Publication
(10) Pub. No.: US 2008/0093182 A1
(43) Pub. Date: Apr. 24, 2008

(54) Apparatus and Method for Connecting Hydraulic Brake Lines to Brake Assemblies on Towed Trailers

(76) Inventor: Bernhardt Goettker, Valley Center, CA (US)

Correspondence Address: Rudolf O. Siegesmund;Gordon & Rees, LLP, Suite 2650, 2100 Ross Avenue, Dallas, TX, 75201, US

(21) Appl. No.: 11/560,507

(22) Filed: Nov. 16, 2006

Related U.S. Application Data
(60) Provisional application No. 60/828,120, filed on Oct. 4, 2006.

(51) Int. Cl. B60T 7/20

(52) U.S. Cl. 188/112 R

(57) ABSTRACT

The installation of hydraulic brake lines on trailers can be simplified by using flexible hose sections and a custom three-way coupling adapted to fit in the tight space constraints around a hydraulic fluid port on a brake assembly. The custom three-way coupling has a first fitting for connecting to the hydraulic fluid port the brake assembly, a second fitting for connecting to a flexible tubing section, and a third fitting for connecting to a flexible tubing section. For a single axle trailer or a tandem axle trailer, the hydraulic fluid port on each brake assembly are connected in series using flexible hose sections between the custom three-way couplings. The third fitting on the final custom three-way coupling is capped off at the last brake assembly to be connected.

### CROSS-REFERENCE TO RELATED APPLICATION

The present invention is related to the subject matter of, and claims priority based upon U.S. Provisional Patent Application 60/828,120 (Attorney Docket number UFP 1041646), incorporated herein by reference.

### FIELD OF THE INVENTION

The present invention relates generally to towed trailers, and relates specifically to hydraulic brake line connections to brake assemblies on towed trailers.

### BACKGROUND OF THE INVENTION

Hydraulic braking systems are commonly found on towed trailers. Surge braking systems are the most common hydraulic braking systems used on trailers. Surge braking systems have an actuator in the trailer's tongue that compresses a reservoir of brake fluid in response to deceleration of the tow vehicle. Additionally, hydraulic braking systems on trailers activate the brakes in the event that the trailer becomes unhitched from the tow vehicle. U.S. Pat. No. 5,013,059 and U.S. Pat. No. 5,040,816 disclose hydraulic surge braking systems for trailers. A less common form of a trailer hydraulic braking system uses an electrically controlled actuator and an electric pump to compress the reservoir of brake fluid in response to electrical signals from the tow vehicle. U.S. Pat. No. 5,346,289 discloses an electric control valve for use with electrically controlled hydraulic braking systems. For both surge braking systems and electrically controlled hydraulic braking systems, hydraulic brake lines transmit pressure from the compressed reservoir of hydraulic fluid to a brake assembly. A brake assembly comprises a drum brake or a disk brake mated to a wheel.

To slow a towed trailer, hydraulic braking system actuators pressurize brake fluid in brake lines to activate brake assemblies at the wheels of the trailer. The actuator may comprise multiple components such as a valve, a piston, a cylinder, a pump, and a brake fluid reservoir. In a drum type brake assembly, pressurized brake fluid causes brake shoes attached to the axle to press against the inside of a rotating drum affixed to a wheel. The friction of the brake shoes against the drum slows the towed trailer. In a disk type brake assembly, pressurized brake fluid causes brake pads inside of a set of calipers attached to the axle to squeeze against the outside of a rotor affixed to a wheel. The friction of the brake pads against the rotor slows the towed trailer.

Traditionally, hydraulic brake lines on a trailer comprise a system combining flexible hose sections and hard tubing sections. Hard tubing sections, mounted to brackets, generally run the length of the trailer and across the axles. Flexible hose sections connect the actuator to the hard tubing, connect the hard tubing sections together, and connect the hard tubing sections to the brake assemblies. Fittings are required to connect the flexible hose sections to the actuator, to the hard tubing sections, and to the brake assemblies. Fitting are generally threaded inverted flare fittings, but other fittings are also known in the art. Each fitting has the potential to leak, causing a braking failure. Installing brackets required to support hard tubing sections and installing all the required fittings adds labor and material costs to brake systems on a towed trailer.

FIG. 1 shows a common hydraulic brake line installation for single axle trailer 100. First fitting 171 connects hydraulic actuator 110 to first flexible hose 150. Second fitting 172 connects first flexible hose 150 to first hard tubing section 120. Third fitting 181 connects first hard tubing section 120 to first straight coupling 130. Fourth fitting 182 connects first straight coupling 130 to second hard tubing section 122. Fifth fitting 173 connects second hard tubing section 122 to second flexible hose 154 at first bracket 144. Sixth fitting 174 connects second flexible hose 154 to first T-coupling 136. Seventh fitting 186 connects third hard tubing section 126 to first T-coupling 136. Eighth fitting 192 connects third hard tubing section 126 to second brake assembly 162. Ninth fitting 185 connects fourth hard tubing section 128 to first T-coupling 136. Tenth fitting 191 connects fourth hard tubing section 128 to first brake assembly 161. Hydraulic brake line installation for single axle trailer 100 requires ten fittings, four hard tubing sections, two flexible hose sections, one bracket, one T-coupling, and one straight coupling, totaling nineteen component parts.

FIG. 2 shows a common hydraulic brake line installation for tandem axle trailer 200. First fitting 271 connects hydraulic actuator 210 to first flexible hose 250. Second fitting 272 connects first flexible hose 250 to first hard tubing section 220. Third fitting 281 connects first hard tubing section 220 to first straight coupling 230. Fourth fitting 282 connects first straight coupling 230 to second hard tubing section 222. Fifth fitting 273 connects second hard tubing section 222 to second flexible hose 254 at first bracket 244. Sixth fitting 274 connects second flexible hose 254 to first T-coupling 234. Seventh fitting 283 connects third hard tubing section 224 to first T-coupling 234. Eighth fitting 275 connects third hard tubing section 224 to third flexible hose 256 at second bracket 246. Ninth fitting 276 connects third flexible hose 256 to second T-coupling 236. Tenth fitting 284 connects fourth hard tubing section 225 to first T-coupling 234. Eleventh fitting 277 connects fourth hard tubing section 225 to fourth flexible hose 258 at third bracket 248. Twelfth fitting 278 connects fourth flexible hose 258 with third T-coupling 238. Thirteenth fitting 286 connects fifth hard tubing section 226 to second T-coupling 236. Fourteenth fitting 292 connects fifth hard tubing section 226 to second brake assembly 262. Fifteenth fitting 285 connects sixth hard tubing section 228 to second T-coupling 236. Sixteenth fitting 291 connects sixth hard tubing section 228 to first brake assembly 261. Seventeenth fitting 288 connects seventh hard tubing section 229 to third T-coupling 238. Eighteenth fitting 267 connects seventh hard tubing section 229 to fourth brake assembly 264. Nineteenth fitting 287 connects eighth hard tubing section 227 to third T-coupling 238. Twentieth fitting 293 connects eighth hard tubing section 227 to third brake assembly 236. Hydraulic brake line installation for single axle trailer 200 requires twenty fittings, eight hard tubing sections, four flexible hose sections, three T-couplings, and one straight coupling, totaling thirty-six component parts.

FIG. 3A shows flexible hose 310 and disk brake assembly 300. Fitting 320 mates with hydraulic brake fluid port 330 to connect flexible hose 310 to brake assembly 300. FIG. 3B shows flexible hose 310 connected to disk brake assembly 300. Generally, fitting 320 is a male swivel inverted flare fitting, and hydraulic brake fluid port 330 is a female inverted flare fitting.

A need exists for a way to simplify the installation of hydraulic brake lines on trailers. The simplified installation should reduce the number of fittings and mounting brackets required to deliver brake fluid to brake assemblies and should replace hard tubing sections with flexible hose sections.

### SUMMARY OF THE INVENTION

The installation of hydraulic brake lines on trailers can be simplified by using flexible hose sections and a custom three-way coupling adapted to fit in the tight space constraints around a hydraulic fluid port on a brake assembly. The custom three-way coupling has a first fitting for connecting to a hydraulic fluid port the brake assembly, a second fitting for connecting to a flexible tubing section, and a third fitting for connecting to a flexible tubing section.

For a single axle trailer, the first fitting of the custom three-way coupling connects to a hydraulic brake fluid port on the first brake assembly. The second fitting of the custom three-way coupling connects with a first section of flexible tubing and the first section of flexible tubing connects to connecting a hydraulic brake actuator. The third fitting of the custom three-way coupling connects to a second section of flexible tubing and the second section of flexible tubing connects to a hydraulic brake fluid port on a second brake assembly. Alternatively, the first fitting of a second custom three-way coupling is attached to the second brake assembly. The second section of flexible tubing attaches to the second fitting of the second custom three-way coupling, and the third fitting of the second custom three-way coupling is capped off.

For a tandem axle trailer, the four brake assemblies are connected in series using flexible hose sections. The first fitting of a first custom three-way coupling connects to a hydraulic brake fluid port on the first brake assembly. The second fitting of the first custom three-way coupling connects to a first section of flexible tubing, and the first section of flexible tubing connects to a hydraulic brake actuator. The third fitting of the first custom three-way coupling connects to a second section of flexible tubing and the second section of flexible tubing connects to a second fitting on a second custom three-way coupling, wherein a first fitting on the second custom three-way coupling is connected to a hydraulic brake fluid port on a second brake assembly. The third fitting of the second custom three-way coupling connects to a third section of flexible tubing and the third section of flexible tubing connects to a second fitting on a third custom three-way coupling, wherein a first fitting on the third custom three-way coupling is connected to a hydraulic brake fluid port on a third brake assembly. The third fitting on the third custom three-way coupling connects to a fourth section of flexible tubing, and the fourth section of flexible tubing to a hydraulic brake fluid port on a fourth brake assembly. Alternatively, the first fitting of a fourth custom three-way coupling is attached to the fourth brake assembly. The fourth section of flexible tubing attaches to the second fitting of the fourth custom three-way coupling, and the third fitting of the fourth custom three-way coupling is capped off.

### BRIEF DESCRIPTION OF DRAWINGS

The novel features believed characteristic of the invention are set forth in the appended claims. The invention itself however, as well as a preferred mode of use, further objectives and advantages thereof, will be understood best by reference to the following detailed description of an illustrative embodiment when read in conjunction with the accompanying drawings, wherein:

FIG. 1 illustrates a prior art single axle brake line installation;

FIG. 2 illustrates a prior art brake tandem axle line installation;

FIG. 3A illustrates a prior art brake line and a brake assembly;

FIG. 3B illustrates a prior art brake line connected to a brake assembly;

FIG. 4 illustrates a two brake lines, a custom three-way coupling and a brake assembly;

FIG. 5 illustrates a single axle brake line installation using a custom three-way coupling;

FIG. 6 illustrates a tandem axle brake line installation using custom three-way couplings;

FIG. 7A illustrates an embodiment of a custom three-way coupling;

FIG. 7B illustrates a banjo style custom three-way coupling; and

FIG. 8 illustrates a custom three-way coupling integrated with a brake assembly.

### DETAILED DESCRIPTION OF THE PREFERRED EMBODIMENT

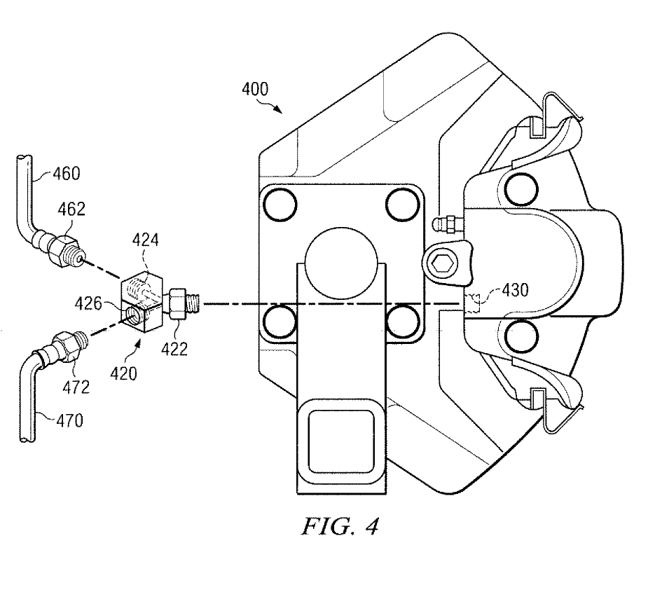

The installation of hydraulic brake lines on trailers can be simplified by using a custom three-way hydraulic brake fluid coupling 420 on brake assembly 400 as shown in FIG. 4. Three-way coupling 420 is adapted to fit in the tight space surrounding hydraulic brake fluid port 430 designed to accept a single brake line fitting. Three-way coupling 420 has first fitting 422, second fitting 424 and third fitting 426. In a preferred embodiment, first fitting 422 is a male swivel inverted flare fitting, second fitting 424 is a female inverted flare fitting, and third fitting 426 is a female inverted flare fitting. First fitting 422 connects three-way coupling 420 to hydraulic brake fluid port 430 on brake assembly 400. Fitting 462 on flexible tubing 460 connects to second fitting 424 on three-way coupling 420. Fitting 472 on flexible tubing 470 connects to third fitting 426 on three-way coupling 420. By using three-way coupling 420 on a hydraulic braking system, the brake assemblies can be connected in series using flexible hose rather than using T-couplings and hard tubing to connect brake assemblies in parallel.

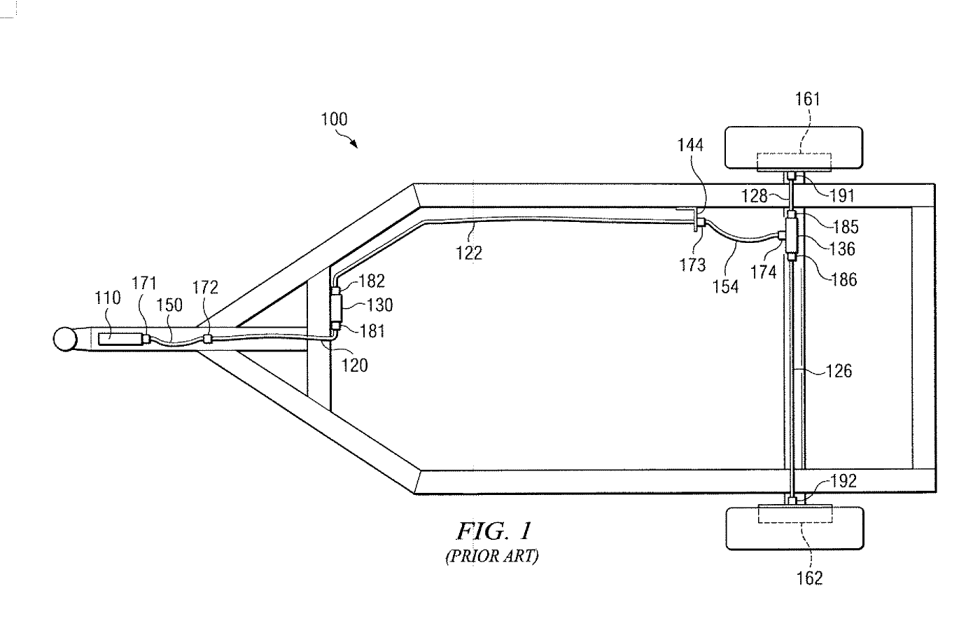

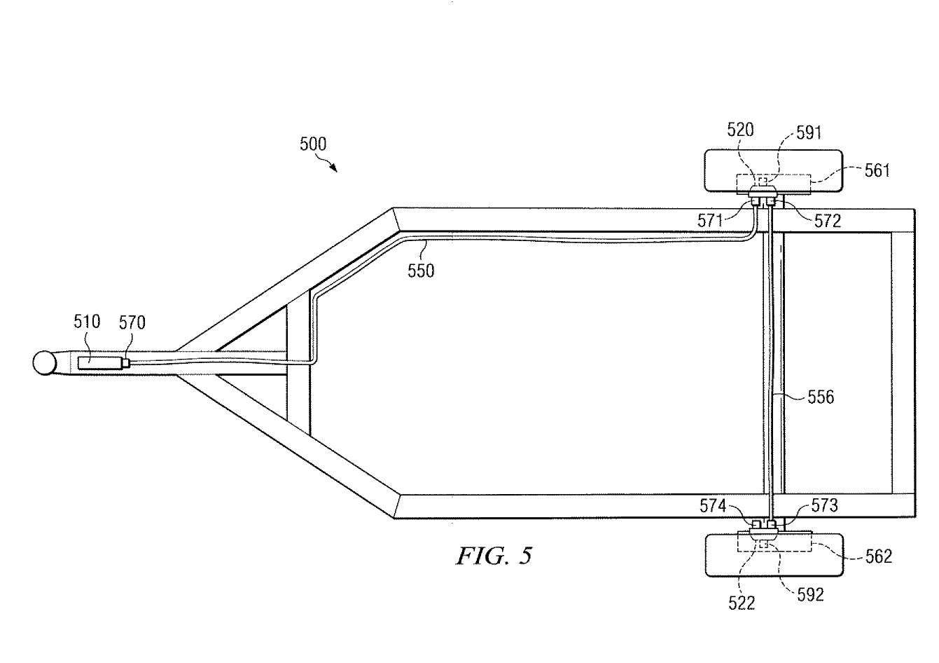

The installation of hydraulic brake lines on single axle trailer 500 using custom three-way couplings is shown in FIG. 5. First fitting 570 connects first flexible hose 550 to actuator 510. Second fitting 571 connects first flexible hose 550 connects to first three-way coupling 520. Third fitting 591 connects first three-way coupling 520 to first brake assembly 561. Fourth fitting 572 connects second flexible hose 556 connects to custom three-way coupling 520. Fifth fitting 573 connects flexible hose 556 to second three-way coupling 522. Sixth fitting 592 connects second three-way coupling 522 to second brake assembly 562. Seventh fitting 574 is capped off. Hydraulic brake line installation for single axle trailer 500 requires seven fittings and two flexible hose sections, and two custom three-way coupling, totaling ten component parts. The brake line installation using custom three-way coupling 520 is much simpler than the prior art brake line installation shown in FIG. 1 using nineteen component parts. Alternatively, second flexible hose 556 can connect directly to second brake assembly 562, alleviating the need for second three-way coupling 522.

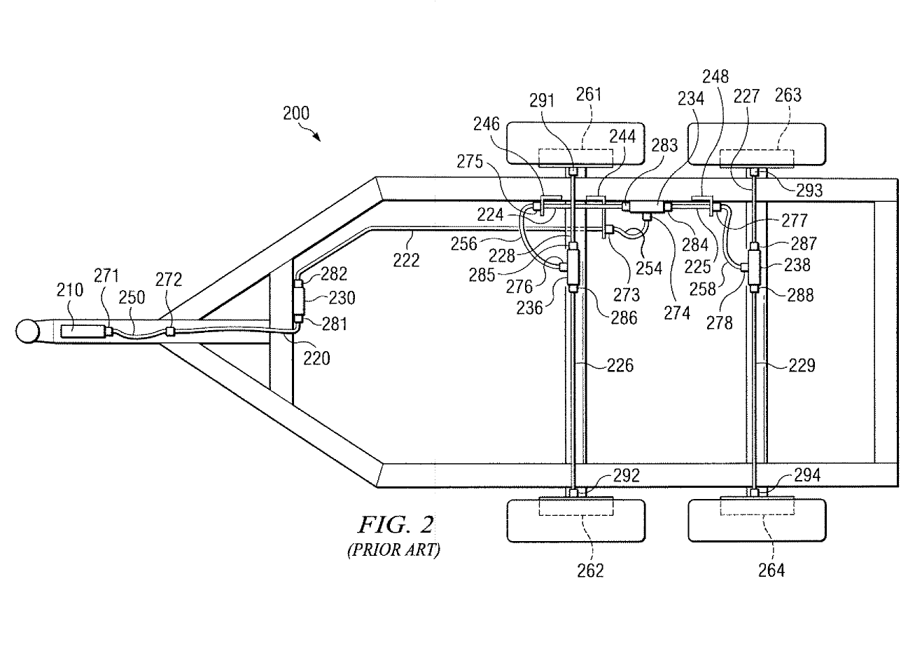

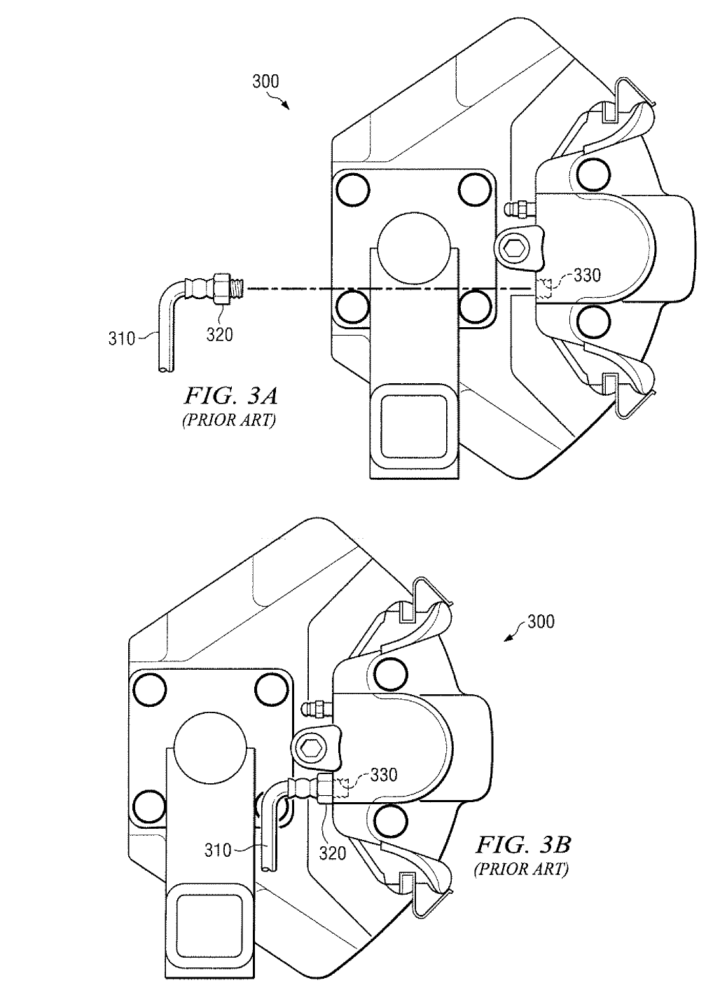

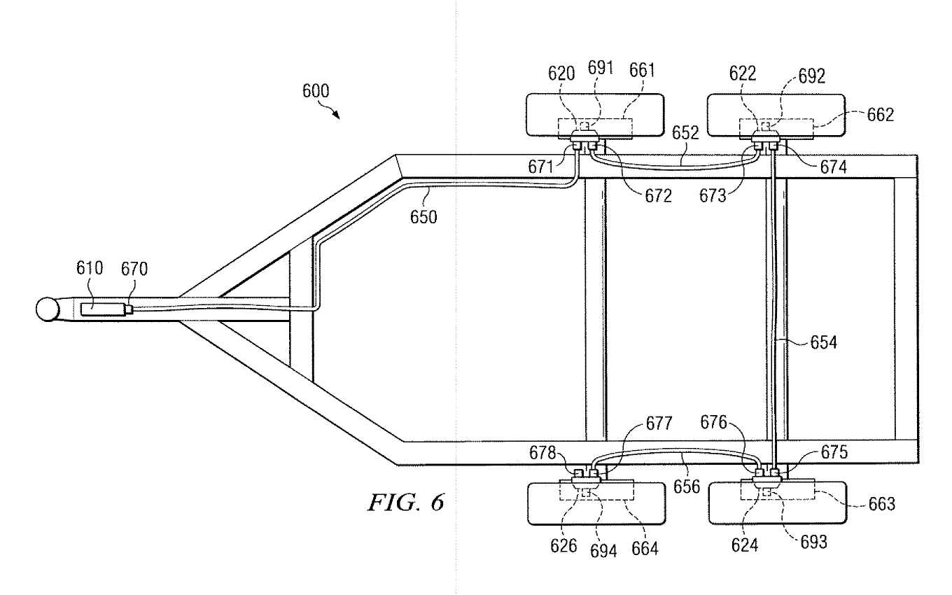

The installation of hydraulic brake lines on tandem axle trailer 600 using custom three-way couplings is shown in FIG. 6. First fitting 670 connects first flexible hose 650 connects to actuator 610. Second fitting 671 connects first flexible hose 650 to first custom three-way coupling 620. Third fitting 691 connects first custom three-way coupling 620 to first brake assembly 661. Fourth fitting 672 connects first custom three-way coupling 620 to second flexible hose 652. Fifth fitting 673 connects second flexible hose 652 to second custom three-way coupling 622. Sixth fitting 692 connects second custom three-way coupling 622 to second brake assembly 662. Seventh fitting 674 connects second custom three-way coupling 622 to third flexible hose 654. Eighth fitting 675 connects third flexible hose section to third custom three-way coupling 624. Ninth fitting 693 connects third custom three-way coupling 624 to third brake assembly 663. Tenth fitting 676 connects third custom three-way coupling 624 to fourth flexible hose 656. Eleventh fitting 694 connects fourth flexible hose 656 to fourth custom three-way coupling 626. Twelfth fitting 694 connects fourth custom three-way coupling 624 to fourth brake assembly 664. Thirteenth fitting 678 is capped off. Hydraulic brake line installation for single axle trailer 600 requires thirteen fittings, four flexible hose sections, and four custom three-way couplings, totaling nineteen component parts. The brake line installation in FIG. 6 using custom three-way couplings is much simpler than the prior art brake line installation shown in FIG. 2 using thirty-six component parts. The reduction in parts is attributed to the use of the custom three-way coupling at the brake assemblies and the use of only flexible hose for all brake lines. Alternatively, fourth flexible hose 656 can connect directly to fourth brake assembly 664, alleviating the need for fourth three-way coupling 624.

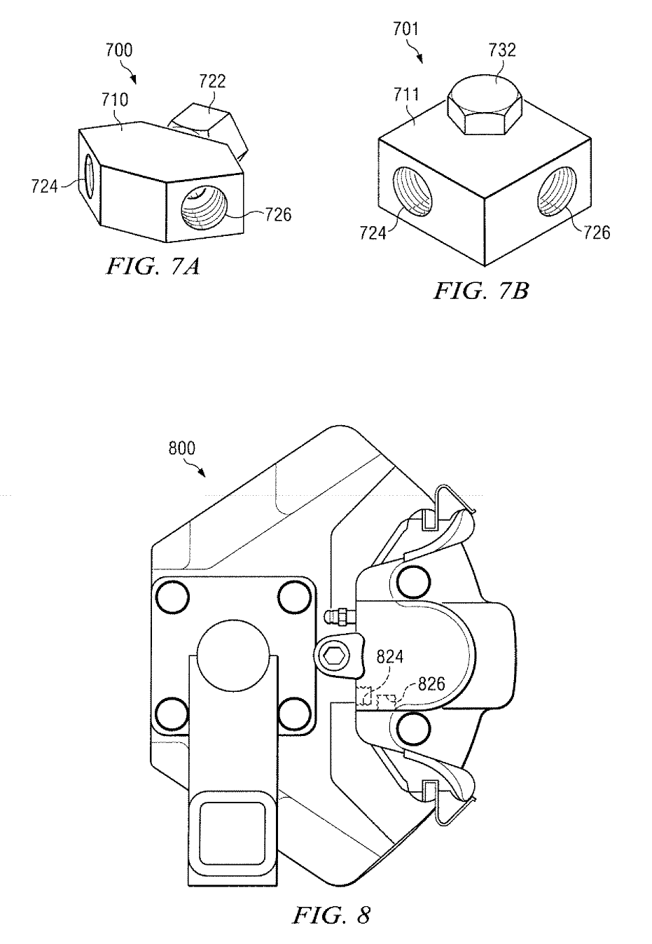

A preferred embodiment of three-way coupling 700 is shown in FIG. 7A. Housing 710 has a generally hexagonal profile, adapted to fit the space surrounding a hydraulic fluid port on a brake assembly. First fitting 722 is adapted to connect housing 710 to a hydraulic fluid port. In this embodiment, fitting 722 is a male swivel inverted flare fitting, but other fittings are known in the art. Second fitting 724 is adapted to connect the housing to a first flexible hose brake line. Second fitting 724 is shown as a female inverted flare fitting, but other fittings are known in the art. Third fitting 726 is adapted to connect the housing to a first flexible hose brake line. Third fitting 726 is shown as a female inverted flare fitting, but other fittings are known in the art. Additionally, housing 710 is not limited to a hexagonal profile with threaded compression fittings extending out along the same horizontal plane. Different fitting types and housing shapes may be used depending on the configuration of the brake assembly. Further, the second fitting and the third fitting can extend at any angle from each other that fits the configuration of the brake assembly. For example, some brake assemblies use a “banjo” hose mounting as shown in FIG. 7B. For banjo hose mounting 701, first fitting 732 is a bolt that attaches housing 711 directly to the hydraulic fluid port on a brake assembly, permitting the passage of the hydraulic fluid between housing 711 and the brake assembly. Second fitting 724 and third fitting 726 each extend at a 90 degree angle from first fitting 732. In banjo hose mounting 701, second fitting 724 and third fitting 726 can extend at any angle from each other that fits the configuration of the brake assembly, such as 60 degrees or 180 degrees.

An additional embodiment of a custom three-way coupling is integrated directly with a brake assembly as shown in FIG. 8. Brake assembly 800 has two hydraulic fluid ports. First hydraulic fluid port 824 is the functional equivalent of the second fitting of the custom three-way coupling, and second hydraulic fluid port 826 is the functional equivalent of the third fitting of the custom three-way coupling. I this additional embodiment, the first fitting and housing are unnecessary. The second hydraulic fluid port can be added next to an existing hydraulic fluid port on the brake assembly, or the brake assembly can be manufactured with two hydraulic fluid ports.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A three-way hydraulic brake coupling for a trailer comprising:
a housing adapted to fit in the space surrounding a hydraulic fluid port on a brake assembly;
a first fitting adapted to connect the housing to the hydraulic fluid port;
a second fitting adapted to connect the housing to a first brake line; and
a third fitting adapted to connect the housing to a second brake line.

2. The three-way hydraulic brake coupling of claim 1 wherein the housing forms a Y-shaped coupling.

3. The three-way hydraulic brake coupling of claim 1 wherein the housing forms a T-shaped coupling.

4. The three-way hydraulic brake coupling of claim 1 wherein the housing and first fitting comprise a banjo style hose mounting.

5. The three-way hydraulic brake coupling of claim 1 wherein:
the first fitting is connected to a hydraulic brake fluid port on a first brake assembly;
the first brake line is connected to a hydraulic actuator; and
the second brake line is connected to a hydraulic fluid port on a second brake assembly.

6. The three-way hydraulic brake coupling of claim 1 wherein:
the first fitting is connected to a hydraulic brake fluid port on a first brake assembly;
the first brake line is connected to a hydraulic actuator; and
the second brake line is connected to a second three-way hydraulic brake coupling connected to a second brake assembly.

7. The three-way hydraulic brake coupling of claim 1 wherein the housing and the first fitting are integrated into the brake assembly.

8. The three-way hydraulic brake coupling of claim 6 wherein the second fitting is a first hydraulic fluid port on the brake assembly and the third fitting is a second hydraulic fluid port on the brake assembly.

9. A method of installing a hydraulic braking system on a trailer, the method comprising:
connecting a first three-way hydraulic brake coupling to a first brake assembly, wherein the three-way hydraulic brake coupling comprises a first fitting, a second fitting and a third fitting and the first fitting connects the first three-way hydraulic coupling to a first hydraulic brake fluid port on the first brake assembly;
connecting the second fitting of the first three-way hydraulic brake coupling to a first section of flexible tubing;
connecting the first section of flexible tubing to a hydraulic brake actuator;
connecting the third fitting of the first three-way hydraulic brake coupling to a second section of flexible tubing;
connecting the second section of flexible tubing to a second fitting on a second three-way hydraulic brake coupling, wherein a first fitting on the second three-way hydraulic brake coupling is connected to a hydraulic brake fluid port on a second brake assembly; and
connecting a cap the third fitting of the second three-way hydraulic brake coupling.

10. The method of claim 9 wherein the second section of flexible tubing connects directly to the hydraulic fluid port on the second brake assembly.

11. A method installing a hydraulic brake system on a tandem axle trailer, the method comprising:
connecting a three-way hydraulic brake coupling to a first brake assembly, wherein the three-way hydraulic brake coupling comprises a first fitting, a second fitting and a third fitting and the first fitting connects the three-way hydraulic coupling to a hydraulic brake fluid port on the first brake assembly;
connecting the second fitting of the first three-way hydraulic brake coupling to a first section of flexible tubing;
connecting the first section of flexible tubing to a hydraulic brake actuator;
connecting the third fitting of the first three-way hydraulic brake coupling to a second section of flexible tubing;
connecting the second section of flexible tubing to a second fitting on a second three-way hydraulic brake coupling, wherein a first fitting on the second three-way hydraulic brake coupling is connected to a hydraulic brake fluid port on a second brake assembly;
connecting the third fitting of the second three-way hydraulic brake coupling to a third section of flexible tubing;
connecting the third section of flexible tubing to a second fitting on a third three-way hydraulic brake coupling, wherein a first fitting on the third three-way hydraulic brake coupling is connected to a hydraulic brake fluid port on a third brake assembly;
connecting the third fitting on the third three-way hydraulic brake coupling to a fourth section of flexible tubing;
connecting the fourth section of flexible tubing to a second fitting on a fourth three-way hydraulic brake coupling, wherein a first fitting on the fourth three-way hydraulic brake coupling is connected to a hydraulic brake fluid port on a fourth brake assembly; and
connecting a cap the third fitting of the fourth three-way hydraulic brake coupling.

12. The method of claim 11 wherein the fourth section of flexible tubing connects directly to the hydraulic fluid port on the fourth brake assembly.
